(19) United States
(12) Patent Application Publication
(10) Pub. No.: US 2021/0025999 A1
(43) Pub. Date: Jan. 28, 2021

(54) DEVICE FOR THE DIAGNOSIS OF OPTOELECTRONIC SYSTEMS AND ASSOCIATED METHOD

(71) Applicant: LEOSPHERE, Paris (FR)

(72) Inventor: Julien SARRY, Munich (DE)

(21) Appl. No.: 16/624,709

(22) PCT Filed: Jun. 21, 2018
(86) PCT No.: PCT/EP2018/066609

§ 371 Date: Dec. 19, 2019

(30) Foreign Application Priority Data
Jun. 21, 2017 (FR) 1755636

(51) Int. Cl. G01S 7/497; G01S 17/06; G01J 1/42

(52) U.S. Cl. CPC G01S 7/4972; G01J 1/4257; G01S 17/06

(57) ABSTRACT

A method for measuring parameters of one or more optical beams emitted by an optoelectronic system, and an associated device. The measurement method includes a calculation of a position of an attachment area of a movement system on which an optical device is attached, such that an alignment axis of the attachment zone coincides with an expected emission axis of the optical beam. The calculation is carried out based on characteristic data of the optoelectronic system. The method includes positioning the attachment area relative to the optoelectronic system, in the calculated position, and a measurement of one or more parameters of the optical beam by the optical device.

### TECHNICAL FIELD

The present invention relates to the field of the optoelectronic systems comprising a system for the emission and/or reception of optical beams and in particular to the optoelectronic systems emitting one or more laser beams. The invention further relates to optoelectronic systems the emitted laser beam or beams of which are spatially shaped via complex optomechanical devices. The optoelectronic systems concerned are in particular LIDAR systems.

The present invention relates to a device for measuring parameters of optical beams emitted by an optoelectronic device and an associated method. The invention further makes it possible to prepare a diagnosis of the optoelectronic system, in particular based on spatial characteristics of the optical beams measured with a metrological property, in order to calibrate the optoelectronic system, for example at the exit from the production line. By way of example, the measurements taken make it possible to determine, among others, an angular deviation between the spatial position of the axis of propagation of the beam measured by the measurement device and the spatial position of the axis of propagation of the theoretical beam.

### STATE OF THE PRIOR ART

Measurement methods are known in the state of the art for the calibration of LIDAR devices. These measurement methods are carried out by users outdoors and are operator-dependent. In order to reduce the dependency of the measurement on the operator who carries it out, a hard target handled by an operator is positioned at a long distance from the LIDAR. Despite the long distances, typically greater than one hundred metres, operator influence on the measurement still persists. In addition, the handling of the hard targets by the operators, combined with the long distances separating the LIDAR from the targets, renders the time for implementing the method significantly long. Another problem inherent in the known methods of the state of the art arises from the fact that, taking account of the long distances travelled by the beams outdoors, the atmospheric conditions lead to a significant variability of the measurements and may even prevent them.

An aim of the invention is in particular to propose a method and a device making it possible to overcome the aforementioned drawbacks at least partially.

A further aim is to propose a method and a device making it possible to carry out such measurements indoors.

### DISCLOSURE OF THE INVENTION

To this end, according to a first aspect of the invention, a method is proposed for measuring parameters of an optical beam emitted by an optoelectronic system, said method comprising:
calculating a position of an attachment zone of a movement system on which an optical device is attached, such that an alignment axis of the attachment zone coincides with an expected emission axis of the optical beam, the calculation being carried out based on characteristic data of the optoelectronic system,
positioning the attachment zone, with respect to the optoelectronic system, in the calculated position,
measuring one or more parameters of the optical beam by the optical device.

By “parameters of the optical beam” is meant any characteristic of the beam, such as, among others, a vector parameter, a spatial parameter, a temporal parameter, a frequency parameter, a geometric parameter, a physical parameter, for example an intensity, a phase parameter.

The optoelectronic system can be a LIDAR. The term LIDAR, known to a person skilled in the art, is an acronym of “LIght Detection and Ranging”.

The movement system can be a movement system with automatic control, such as, among others, a robotic arm or hexapod or any inclined platform.

The robotic arm can be articulated.

The movement system with automatic control can be industrial.

The attachment zone can be a surface of the movement system, positioning and inclination of which are controlled.

The optical sensor coincides with a focal plane of the optical device.

By “expected emission axis of the optical beam” is meant the theoretical emission axis along which said optical beam should be emitted.

By “positioning” an object is meant the combination of a position in space and an orientation of said object.

The alignment axis of the attachment zone extends from the attachment zone and the movement system is arranged to position the attachment zone in space and to orient said alignment axis of the attachment zone.

Calculation of the position of the attachment zone can make it possible, among others, to obtain a set of data pairs, each data pair comprising a position and an orientation of the attachment zone.

Advantageously, the positioning of the attachment zone is carried out at a distance less than four metres, preferably less than two metres, more preferably less than one metre from the optoelectronic system. Advantageously, the positioning of the attachment zone is carried out at a distance comprised between five and thirty centimetres from the optoelectronic system.

The method can comprise determining, by a processing unit, based on the measured parameter or parameters:
a spatial positioning of a vector representative of the optical beam, and/or
spectral characteristics of the optical beam, and/or
temporal characteristics of the optical beam, and/or
a polarization rate of the optical beam, and/or
a gaussian propagation property of the optical beam, and/or
characteristics associated with the phase of the optical beam, and/or
a wave front of the optical beam, and/or
an efficiency of the optoelectronic system, and/or
an optical power of the optical beam.

A vector representative of the optical beam can for example be defined by a starting position in space of the optical beam, which can for example be integrated with the exit point of the optoelectronic system, and a direction defined in a frame of reference.

The method can comprise:
acquiring a first position of the optical beam on the optical sensor of the optical device, the optical device being a camera,
at least one step of rotation of the attachment zone with respect to the alignment axis of the attachment zone, an optical axis of the camera describing a precession movement about the expected emission axis,
concomitantly with or subsequent to the at least one step of rotation, acquiring at least one second position of the optical beam on the optical sensor,
based on the positions of the optical beam on the optical sensor, determining an angular deviation between the expected emission axis of the optical beam and a real emission axis of the optical beam.

The optical device is chosen as a function of the measured parameter.

The camera is equipped with an objective chosen in an advantageous manner.

The camera is equipped with an objective that can be chosen as a function of the measured parameter.

The precession movement of the optical axis of the camera about the expected emission axis is caused by a misalignment of the optical axis of the camera with the alignment axis of the attachment zone.

The misalignment of the optical axis of the camera with respect to the alignment axis of the attachment zone means that after a rotation of the attachment zone with respect to the axis, the at least one second position of the optical beam on the sensor will be different from the first position of the optical beam on the sensor.

The misalignment of the optical axis of the camera with respect to the alignment axis of the attachment zone means that a position of the optical beam on the optical sensor is a position of a fictitious optical focal spot.

Acquiring at least one second position of the optical beam on the optical sensor makes it possible to determine the angular deviation based on the two positions of the optical beam on the sensor, the direction of rotation of the attachment zone and the angle of rotation carried out during the rotation step.

When the step of acquiring the at least one second position of the optical beam on the sensor is carried out subsequent to the at least one step of rotation and the rotation of the attachment zone with respect to the alignment axis of the attachment zone is greater or lesser by more than one degree with respect to an angle of 180°, the step of acquiring the at least one second position comprises at least:
acquiring a second position, and
acquiring a third position.

When the method comprises acquiring at least one second position of the optical beam on the optical sensor, the method can comprise determining:
a position of a real optical focal spot of the camera on the optical sensor by the processing unit, the position of the real optical focal spot corresponding to the position of a centre of a circle linking the first and the at least one second position of the optical beam on the optical sensor,
the real emission axis of the optical beam, said axis comprising the position of the real optical focal spot on the optical sensor and an optical centre of the camera.

Determining the position of the real optical focal spot makes it possible to overcome any misalignment of the optical device with respect to the alignment axis of the attachment zone.

When the step of acquiring at least one second position is carried out subsequent to the at least one step of rotation and the rotation of the attachment zone with respect to the alignment axis of the attachment zone is substantially equal to an angle of 180°, the step of acquiring at least one second position can comprise acquiring one second position only.

When the step of acquiring at least one second position comprises acquiring only one second position, the method can comprise determining:
the position of the real optical focal spot of the camera on the optical sensor by the processing unit, the position of the real optical focal spot corresponding to a mid-point of a straight line linking the first position to the second position,
the real emission axis of the optical beam, said axis comprising the position of the real optical focal spot on the optical sensor and the optical centre of the camera.

A maximum angular deviation between the expected emission axis of the optical beam and a real emission axis of the optical beam is less than ±15° so that the emitted beam is focused by the camera on the optical sensor.

The maximum angular deviation is less than ±10°, preferably ±5°.

Advantageously, the angular deviation is less than ±2°.

The method can comprise at least one iteration of the steps of:
acquiring the first position of the optical beam on the optical sensor,
at least one rotation of the attachment zone with respect to the alignment axis of the attachment zone,
acquiring the at least one second position of the optical beam on the optical sensor, and
determining:
   the angular deviation between the expected emission axis of the optical beam and the real emission axis of the optical beam, and/or
   a position of a real optical focal spot of the camera on the optical sensor, and/or
   the real emission axis of the optical beam, and/or
   the difference between the expected angle between two optical beams and the real angle between two optical beams;
      each iteration being carried out at a different positioning of the attachment zone along the expected emission axis of the optical beam.

In other words, for the first iteration, the attachment zone is positioned:
in the direction of the exit point of the optoelectronic system,
along the expected emission axis of the optical beam,
at a distance from the exit point of the optoelectronic system that is different from the distance from the exit point of the optoelectronic system at which the attachment zone was positioned during the preceding implementation of the steps of:
   acquiring the first position of the optical beam on the optical sensor,
   at least one rotation of the attachment zone with respect to the alignment axis of the attachment zone,
   acquiring the at least one second position of the optical beam on the optical sensor.

In other words, for each iteration, the attachment zone is positioned:
in the direction of the exit point of the optoelectronic system,
along the expected emission axis of the optical beam,
at a distance from the exit point of the optoelectronic system that is different from each of the other distances from the exit point of the optoelectronic system at which the attachment zone is positioned during the implementation of the other iterations.

The method can comprise a calculation of one or more differences, called control differences, between:
the angular deviation between the expected emission axis of the optical beam and the real emission axis of the optical beam determined during an iteration and the angular deviation between the expected emission axis of the optical beam and the real emission axis of the optical beam determined during another iteration, and/or
the real emission axis of the optical beam determined during an iteration and the real emission axis of the optical beam determined during another iteration, and/or
the difference between the expected angle between two optical beams and the real angle between two optical beams determined during an iteration and the difference between the expected angle between two optical beams and the real angle between two beams determined during another iteration.

In the event that a value for the control difference, or a value for one of the control differences, or values for control differences, is(are) greater than the metrological accuracy of the movement system, this indicates:
a defect of implementation of the method, and/or
a defect of calibration of the movement system, and/or
a defect of calibration of the optoelectronic system.

The method can comprise:
an adjustment of an inclination of the optoelectronic system by means of an inclinometer of the optoelectronic system,
calibration of the inclinometer, using the processing unit, based on the angular deviation between the expected emission axis of the optical beam and a real emission axis of the determined optical beam.

Adjustment of the inclination of the optoelectronic system can be carried out prior to the implementation of the method according to the invention.

The optoelectronic system can be mounted on a support that is adjustable with respect to a horizontal plane.

The adjustable support can be arranged to adjust the inclination of the optoelectronic system with respect to the horizontal plane.

The inclinometer can be placed in the optoelectronic system.

According to the invention, the optoelectronic system can emit several optical beams, the method being applied successively to each of said optical beams.

The optical beams can be emitted by one and the same optical source.

The optical beams emitted by the optoelectronic system can be spatially distinct.

The optical beams emitted by one and the same optical source can be oriented successively in different directions over time.

The optical beams emitted by the optoelectronic system can be spatially arranged with respect to one another.

The optical beams emitted by the optoelectronic system can be spatially arranged with respect to the optoelectronic system.

When the optoelectronic system emits several optical beams, the method can comprise determining, by the processing unit, a difference between an expected angle between two optical beams and a real angle between two optical beams.

According to the first aspect of the invention:
the optoelectronic system can be a LIDAR,
the movement system can be a robotic arm,
the attachment zone can be a surface of the robotic arm, positioning and inclination of which are controlled.

According to a second aspect of the invention, a device is proposed for measuring parameters of an optical beam emitted by a LIDAR, said measurement device comprising:
a support suitable for receiving the LIDAR and arranged to modify a positioning of the LIDAR.

According to the invention, the measurement device is characterized in that it also comprises:
a movement system with automatic control comprising an attachment zone suitable for being moved along several axes,
an optical device attached to said attachment zone of the movement system,
the movement system is arranged to position the attachment zone with respect to the LIDAR and to orient an alignment axis of the attachment zone so that the alignment axis coincides with an expected emission axis of the optical beam,
the optical device is arranged to measure one or more parameters of the optical beam.

When the LIDAR emits several optical beams, the measured parameter or parameters of an optical beam can be common to all the optical beams.

When the LIDAR emits several optical beams, a parameter of an optical beam can be different:
from a parameter of another optical beam emitted by the LIDAR, and/or
from a parameter common to other optical beams emitted by the LIDAR, and/or
from a parameter common to all the other optical beams emitted by the LIDAR, and/or
from parameters of another optical beam emitted by the LIDAR, and/or
from parameters of other optical beams emitted by the LIDAR, and/or
from parameters common to other optical beams emitted by the LIDAR, and/or
from parameters common to all other optical beams emitted by the LIDAR.

The attachment zone can be a surface of the movement system, positioning and inclination of which are controlled by said movement system.

Advantageously, the attachment zone can be moved along six axes.

A maximum pitch of a displacement of the attachment zone by the movement system is 1 mm, preferably 0.5 mm.

Advantageously, the pitch of displacement is 0.1 mm.

A maximum pitch of a rotation of the attachment zone by the movement system is 0.05°, preferably 0.025°.

Advantageously, the pitch of displacement is 0.01°.

The device can comprise a processing unit configured and/or programmed to calculate an expected emission axis of the optical beam, based on characteristic data of the LIDAR.

The processing unit can be configured and/or programmed to calculate a position of the attachment zone for which the alignment axis of the attachment zone is aligned with the expected emission axis of the optical beam.

The position of the attachment zone calculated by the processing unit can be defined, among others, by a set of data pairs, each data pair comprising a position and an orientation of the attachment zone.

The movement system with automatic control can be a robotic arm or hexapod or any inclined platform and the attachment zone suitable for being moved is a surface of the movement system, said surface being arranged to be rotated about the alignment axis of the attachment zone.

The movement system with automatic control can be an industrial device.

The robotic arm can be a hexapod. By “hexapod” is meant a device suitable for being moved via six elements.

The attachment zone can be a zone situated at an extremity of the robotic arm.

The alignment axis of the attachment zone can extend from the attachment zone in a predefined direction.

The alignment axis of the attachment zone can extend from the extremity of the robotic arm in a predefined direction.

The support can be mainly comprised in one plane and is arranged to adjust, among others, the angle formed between a horizontal plane and the plane in which the support is comprised.

Advantageously, the support is arranged to adjust an inclination of the support with respect to a horizontal plane.

Advantageously, the support is arranged to adjust an azimuthal orientation of the support.

Adjustment of the inclination of the support can be carried out based on an inclination value measured by an inclinometer of the LIDAR.

The optical device can be arranged in order to measure, among others:
a spatial positioning of a vector representative of the optical beam, and/or
one or more spectral characteristic(s) of the optical beam, and/or
one or more temporal characteristic(s) of the optical beam, and/or
a polarization rate of the optical beam, and/or
a gaussian propagation property of the optical beam, and/or
one or more characteristic(s) associated with the phase of the optical beam, and/or
a wave front of the optical beam, and/or
an efficiency of the optoelectronic system, and/or
an optical power of the optical beam.

The optical device can be, among others:
a wave front analyzer, or
a device for calibrating a LIDAR, or
a device for measuring optical power.

The measurement device can comprise several optical devices.

The measurement device can comprise:
a wave front analyzer, and/or
a device for calibrating a LIDAR, and/or
a device for measuring optical power.

When the measurement device comprises several optical devices, each optical device can be linked to a different movement system, the measurement device comprising the set of movement systems.

When the measurement device comprises several optical devices, a single one of the optical devices at a time can be associated with the attachment zone, the optical devices being successively interchanged thereon in an automated manner and/or manually.

When the measurement device comprises several optical devices, the set of optical devices can be linked concomitantly to the attachment zone of the movement device.

When the set of optical devices is linked concomitantly to the attachment zone of the movement device, only one of the optical devices can be positioned so that the expected emission axis of the optical beam is focused on the optical sensor of said optical device.

When the set of optical devices are linked concomitantly to the attachment zone of the movement device, the set of optical devices can be arranged so that the expected emission axis of the optical beam is focused successively on each of the optical sensors of the optical devices.

When the set of optical devices is linked concomitantly to the attachment zone of the movement device, the set of optical devices can be arranged to be moved so that the expected emission axis of the optical beam is focused successively on each of the optical sensors of the optical devices.

According to the invention:
the optical device can be a camera,
an optical axis of the camera describes a precession movement about the alignment axis,
the camera is arranged to:
   measure spatial positioning of a vector representative of the optical beam,
   be rotated about the alignment axis of the attachment zone,
the processing unit is configured and/or programmed to determine an angular deviation between an expected emission axis of the optical beam and a real emission axis of said optical beam based on at least two positions of said optical beam on an optical sensor of the camera, said at least two positions of the optical beam comprising at least one position acquired subsequently and/or concomitantly and/or after the camera has been rotated.

Advantageously, the optical sensor of the camera is a CCD sensor.

The optical sensor of the camera can be a CMOS sensor.

Advantageously, the optical sensor of the camera has a minimum number of pixels of 1 megapixel.

More preferably, the number of pixels is 1.2 megapixels.

Advantageously, the optical sensor of the camera has a minimum pixel size of 10×10 μm, preferably 5×5 μm.

More preferably, the pixel size is 3.75×3.75 μm. The precession movement of the optical axis of the camera about the expected emission axis is caused by a misalignment of the optical axis of the camera with the alignment axis of the attachment zone.

The misalignment of the optical axis of the camera with the alignment axis of the attachment zone is less than an angle of ±2°.

When the processing unit is configured and/or programmed to determine the angular deviation between the expected emission axis of the optical beam and the real emission axis of said optical beam, the processing unit can be configured and/or programmed to determine:
a position of a real optical focal spot of the camera on the optical sensor, the position of the real optical focal spot corresponding to the position of a centre of a circle linking said at least two positions of the optical beam on the optical sensor,
the real emission axis of the optical beam, said real emission axis comprising the position of the real optical focal spot on the optical sensor and an optical centre of the camera.

When the processing unit is configured and/or programmed to determine the angular deviation between the expected emission axis of the optical beam and the real emission axis of said optical beam, based on only two positions on the optical sensor of the camera, the processing unit can be configured and/or programmed to determine:
the position of the real optical focal spot of the camera on the optical sensor, the position of the real optical focal spot corresponding to a mid-point of a straight line linking the first position to the second position of the optical beam on the optical sensor,
the real emission axis of the optical beam, said axis comprising the position of the real optical focal spot on the optical sensor and the optical centre of the camera.

When the processing unit is configured and/or programmed to determine the angular deviation between the expected emission axis of the optical beam and the real emission axis of said optical beam, the processing unit can be configured and/or programmed to apply the step of determining an angular deviation to a set of beams emitted by the LIDAR.

When the LIDAR emits several optical beams, the measured parameter or parameters of an optical beam can be common to all the optical beams.

When the LIDAR emits several optical beams, a parameter of an optical beam can be different:
from a parameter of another optical beam emitted by the LIDAR, and/or
from a parameter common to other optical beams emitted by the LIDAR, and/or
from a parameter common to all the other optical beams emitted by the LIDAR, and/or
from parameters of another optical beam emitted by the LIDAR, and/or
from parameters of other optical beams emitted by the LIDAR, and/or
from parameters common to other optical beams emitted by the LIDAR, and/or
from parameters common to all other optical beams emitted by the LIDAR.

The optical beams emitted by the LIDAR can be spatially distinct.

The optical beams emitted by the LIDAR can be spatially arranged with respect to one another.

The optical beams emitted by the LIDAR can be spatially arranged with respect to the optoelectronic system.

According to a third aspect of the invention, there is proposed a use of the measurement device according to the second aspect of the invention, in which the optical device is a camera and in which the processing unit is configured and/or programmed to determine a difference between:
an expected angle between two optical beams emitted by a LIDAR, and
a real angle between said two optical beams emitted by the LIDAR.

According to a fourth aspect of the invention, there is proposed a use of the measurement device according to the second aspect of the invention, in which the optical device is a camera and in which the processing unit is configured and/or programmed to calibrate an inclinometer of a LIDAR based on a difference between:
an expected angle between two optical beams emitted by the LIDAR and a real angle between said two optical beams emitted by the LIDAR, and/or
expected angles between several optical beams emitted by the LIDAR and real angles between said several optical beams emitted by the LIDAR.

### DESCRIPTION OF THE FIGURES AND EMBODIMENTS

Other advantages and characteristics of the invention will become apparent on reading the detailed description of implementations and embodiments that are in no way limitative, and from the following attached drawings:

FIG. 1 is a diagrammatic representation of a measurement device according to the second aspect of the invention and a LIDAR,

FIGS. 2a and 2b are two diagrammatic representations in two different positions of an objective and a sensor of a camera of the measurement device, an expected emission axis of one of the beams emitted by the LIDAR, a real emission axis of said one of the beams emitted by LIDAR, and an optical axis, an objective and a sensor of the camera,

FIG. 3 is a diagrammatic representation of positions of an optical beam emitted by the LIDAR on a sensor of the camera,

FIGS. 4a, 4b, 4c, and 4d are diagrammatic representations of the sensor, the objective and the beam emitted by the LIDAR, in positions respectively illustrating:
a theoretical position of an optical axis of the camera with respect to the expected emission axis of the beam emitted by the LIDAR,
a misalignment between the optical axis of the camera and the expected emission axis of the beam emitted by the LIDAR,
a first position of the measurement device in which the optical axis of the camera and the alignment axis have a misalignment between them, and in which the expected emission axis and the real emission axis of the optical beam have an angular deviation between them,
a second position corresponding to a rotation of 180° with respect to the first position of the camera about the alignment axis.

As the embodiments described hereinafter are in no way limitative, variants of the invention can in particular be considered comprising only a selection of the characteristics described, in isolation from the other characteristics described (even if this selection is isolated within a sentence comprising these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

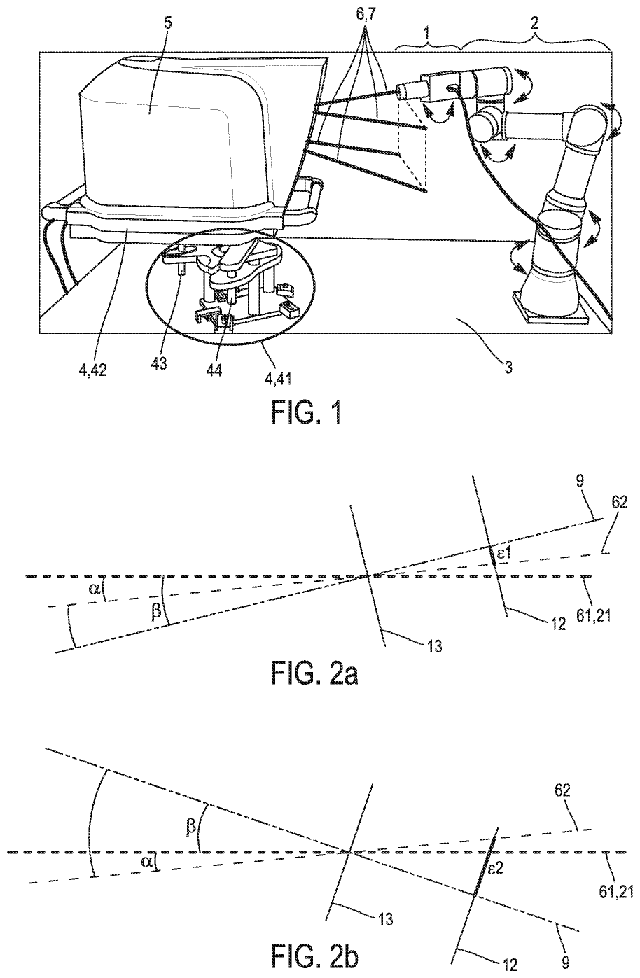

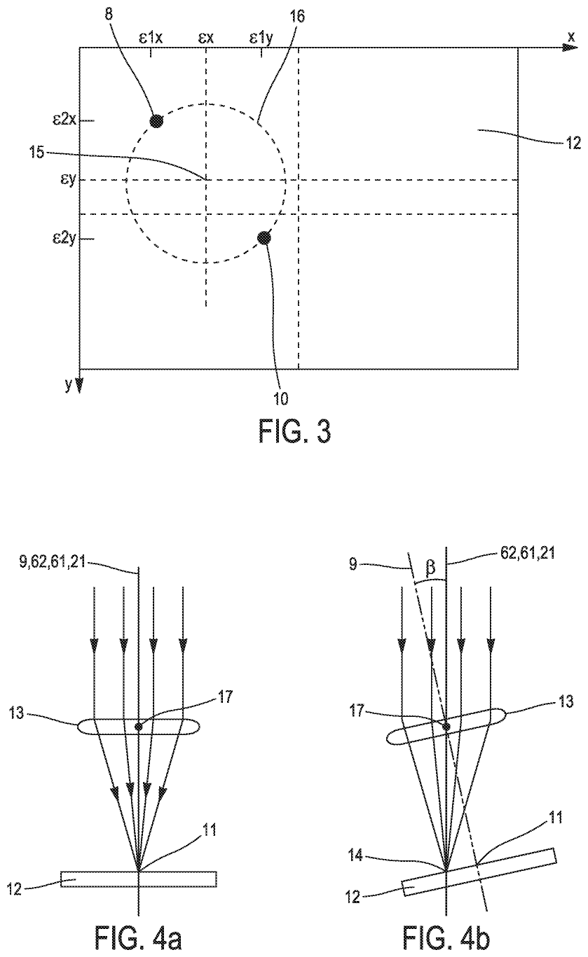

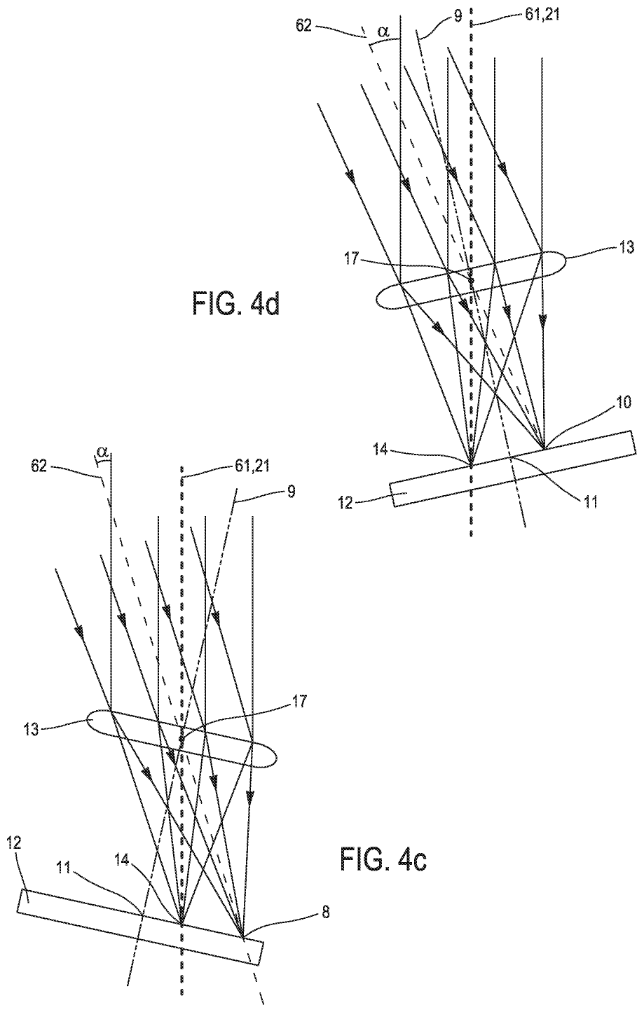

An embodiment of the measurement device 1, 2, 3, 4 and of the measuring method is described with reference to FIGS. 1, 2, 3 and 4, from the position of emission axes 6 of each of the four optical beams 7 emitted by a LIDAR 5. The four beams 7 emitted by the LIDAR are separate and spatially shaped according to a defined geometry.

The measurement device comprises an optical table 3 on which is mounted a support 4 on which the LIDAR 5 is attached. A camera 1 is attached on an attachment zone (not shown) situated at the end of a robotized arm 2. The end of the robotized arm 2 has six degrees of freedom conferred by the different articulations (not referenced) of the robotized arm 2. The camera 1 can be positioned with an accuracy of ±0.5 mm, and the camera 1 can be rotated about an alignment axis 21 of the attachment zone, with an accuracy of ±0.05°. The alignment axis 21 corresponds to the direction extending from the extremity of the robotized arm 2 in which the robotized arm 2 orients the attachment zone.

The support 4 and the robotized arm 2 are attached on the optical table 3 at defined positions. The support 4 is mounted on the optical table 3 relatively to the robotized arm 2, so that the camera 1 can be positioned by the robotized arm 2 at a distance comprised between 5 and 100 cm from the LIDAR 5, and oriented by the robotized arm 2 so as to cover a hemisphere the centre of the base of which is situated at the centre of the optical emission zone of the LIDAR 5.

The camera comprises a CCD sensor 12, the sensor of which comprises 1.2 megapixels and the pixel size of which is 3.75×3.75 μm.

The camera is equipped with an objective 13 the focal distance of which is 50 mm and aperture F/2, therefore 25 mm.

The robotized arm 2 has an angular repeatability of ±0.02° and positioning accuracy of 0.1 mm.

The support comprises an adjustment device 41 of the attitude and azimuth of a stage 42 on which the LIDAR 5 is attached. The adjustment device 41 is attached on the optical table 3. The adjustment device 41 modifies the attitude and azimuth of the stage 42 via two adjustment screws 43, 44. The azimuth is adjusted accurately using a laser alignment system. The attitude is adjusted via data measured by an inclinometer of the LIDAR 5.

A processing unit (not shown) is configured to control the robotized arm 2 and the camera 1. The attachment zone is placed at a position calculated, and oriented in a direction calculated, by the processing unit, so that the alignment axis 21 of the attachment zone coincides with the expected emission axis 61 of one of the beams 7, called first beam, emitted by the LIDAR 5. The position and the direction are calculated based on data relating to the directions of emission of the beams 7 emitted by the LIDAR 5, supplied by the manufacturer.

In the absence of the angular deviation α between the position of the expected emission axis 61 and the position of the real emission axis 62, and in the absence of the angular deviation β between the optical axis 9 of the camera 1 and the alignment axis 21, all the axes 9, 21, 61 and 62 must coincide and the real emission axis 62 must be focused by the objective 13 of the camera 1 at a position 11 on the CCD sensor 12 of the camera 1, the position 11 corresponding to the theoretical optical centre of the camera 1.

In practice, when the camera 1 is mounted on the attachment zone of the end of the robotized arm 2, there is still a non-zero angle β between the optical axis 9 of the camera 1 and the alignment axis 21 of the attachment zone of the robotized arm 2. Thus, in the absence of the angular deviation α between the position of the expected emission axis 61 and the position of the real emission axis 62, but in the presence of an angular deviation between the optical axis 9 of the camera 1 and the alignment axis 21, the real emission axis 62 is focused by the objective 13 of the camera 1 at a position 14 on the CCD sensor 12 of the camera 1, the position 14 corresponding to an optical centre 14 of the camera 1.

In practice, all of the parameters characterizing the optical beams 7 emitted by the LIDAR 5 must be known with accuracy. To this end, the LIDAR 5 is calibrated when leaving the factory. Furthermore, as these parameters are susceptible to drift over time, it is therefore necessary to measure them regularly during the life of the LIDAR. In particular, one of the parameters among the most sensitive and most complex to measure is the spatial position of the emission axes 6 of the optical beams 7 emitted by the LIDAR 5. As the distances of use of the LIDARs are several hundred metres, an angular deviation α of several tens of degrees between the position of the expected emission axis 61 and the position of the real emission axis 62 can result in deviations of the positions of the emitted beams 7 of several metres at the target. In practice, this angular deviation α must be determined in order to calibrate the error resulting from incorrect positioning of the inclinometer on the LIDAR 5. This angular deviation α must also be determined in order to adjust an optomechanical system of the LIDAR 5 during the manufacture of the LIDAR 5.

Thus, in the presence of an angular deviation α between the position of the expected emission axis 61 and the position of the real emission axis 62 and in the presence of an angular deviation β between the optical axis 9 of the camera 1 and the alignment axis 21, the real emission axis 62 is focused by the objective 13 of the camera 1 at a position 15 on the CCD sensor 12 of the camera 1, the position 15 corresponding to the position of a real optical centre 15 of the camera 1.

In a first variant of the embodiment, after the robotized arm 2 has positioned the camera 1 by aligning the alignment axis 21 with the expected emission axis 61, the processing unit acquires a first position 8 of the first beam on the CCD sensor 12 of the camera 1. This first position 8 is defined by the coordinates (ε₁x, ε₁y) thereof on the CCD sensor 12.

After acquiring the first position 8, the robotized arm 2 turns the camera 1 with respect to the alignment axis 21 through an angle of 180°. The processing unit acquires a second position 10 of the first beam on the CCD sensor 12 of the camera 1. This second position 10 is defined by the coordinates (ε₂x, ε₂y) thereof on the CCD sensor 12.

In a second variant of the embodiment, after acquiring the first position 8 of the first beam on the CCD sensor 12 of the camera 1, the robotized arm 2 can operate a continuous rotation of the camera 1 about the alignment axis 21 and the processing unit can continuously acquire a set of positions 16 of the first beam on the CCD sensor 12 of the camera 1. In this case, the set of positions 16 describes a circle 16 comprising the first 8 and second 10 positions.

The processing unit then calculates the position of the real optical centre 15. According to the first variant, the position of the real optical centre 15 is determined by the processing unit by calculating the coordinates of the centre of the segment linking the first position 8 to the second 10. According to the second variant, the position of the real optical centre 15 is determined by the processing unit by calculating the coordinates of the centre of the circle 16.

The processing unit then calculates the position of the real emission axis 62 by calculating the coordinates of the axis linking the optical centre 17 of the camera to the real optical focal spot 15.

Determining the real optical focal spot by rotation of the camera 1 about the alignment axis 21 makes it possible to avoid alignment errors, regardless of the accuracy of the optical sensor used. This determination, combined with the use of a robotized arm 2, confers on the measurement an industrial, repeatable character.

In order to measure minimum angular deviations β, the methods of the state of the art envisage positioning the target at significant distances from the LIDAR 5 so as to result in deviations in the positions of the emitted beams 7 that are sufficiently great to be measured by a physical target moved manually. The method according to the invention makes it possible to measure these minimum angular deviations β by positioning the camera 1 in immediate proximity to the LIDAR 5.

The manual measurement methods known to a person skilled in the art call for two operators during a period of 4 to 6 hours. The device associated with the method according to the invention makes it possible to carry out measurements indoors in a few minutes and does not require any operator during implementation of the method. The device achieves accurate, repeatable measurements that are not operator-dependent and do not depend on any external factor.

The device according to the invention makes it possible to determine an angular deviation to within an accuracy of 0.05°.

After having determined the real emission axis 62 of the first beam, the method is applied to each of the beams 7 emitted by the LIDAR 5. The real positions of the emission axes of each of the beams 7 emitted by the LIDAR 5 are then known.

The processing unit determines the angular differences of the beams 7 emitted by the LIDAR between one another.

Based on the angular differences and the defined geometry according to which the beams 7 were spatially shaped, the processing unit determines an angular deviation between:
the attitude at which the LIDAR 5 was positioned, based on the data measured by the inclinometer, and
a horizontal plane.

The inclinometer is calibrated based on the angular deviation determined.

Of course, the invention is not limited to the examples that have just been described, and numerous modifications may be made to these examples without exceeding the scope of the invention.

In addition, the different characteristics, forms, variants and embodiments of the invention may be combined together in various combinations to the extent that they are not incompatible or mutually exclusive.

1. A method for measuring parameters of an optical beam emitted by an optoelectronic system, said method comprising:
calculating a position and a direction of an attachment zone of a movement system on which an optical device is attached, such that an alignment axis of the attachment zone coincides with an expected emission axis of the optical beam, the calculation being carried out based on data relating to a direction of emission of the beam emitted by the optoelectronic system;
positioning the attachment zone, with respect to the optoelectronic system, in the calculated position; and
measuring one or more parameters of the optical beam by the optical device.

2. The method according to claim 1, comprising:
determining, by a processing unit, based on at least one of the following measured parameter or parameters:
a spatial positioning of a vector representative of the optical beam,
spectral characteristics of the optical beam,
temporal characteristics of the optical beam,
a polarization rate of the optical beam,
a gaussian propagation property of the optical beam,
characteristics associated with the phase of the optical beam,
a wave front of the optical beam,
an efficiency of the optoelectronic system, and
an optical power of the optical beam.

3. The method according to claim 1, comprising:
acquiring a first position of the optical beam on the optical sensor of the optical device, the optical device being a camera,
at least one step of rotation of the attachment zone with respect to the alignment axis of the attachment zone, an optical axis of the camera describing a precession movement about the expected emission axis;
concomitantly with or subsequent to the at least one step of rotation, acquiring at least one second position of the optical beam on the optical sensor; and
based on the positions of the optical beam on the optical sensor, determining an angular deviation between the expected emission axis of the optical beam and a real emission axis of the optical beam.

4. The method according to claim 3, comprising:
determining:
a position of a real optical focal spot of the camera on the optical sensor by the processing unit, the position of the real optical focal spot corresponding to the position of a centre of a circle linking the first and the at least one second position of the optical beam on the optical sensor; and
the real emission axis of the optical beam, said axis comprising the position of the real optical focal spot on the optical sensor and an optical centre of the camera.

5. The method according to claim 3, comprising:
an adjustment of an inclination of the optoelectronic system by means of an inclinometer of the optoelectronic system; and
calibration of the inclinometer, using the processing unit, based on the angular deviation between the expected emission axis of the optical beam and a real emission axis of the determined optical beam.

6. The method according to claim 1, in which the optoelectronic system emits several optical beams, the method being applied successively to each of said optical beams.

7. The method according to claim 6, comprising: determining, by the processing unit, a difference between an expected angle between two optical beams and a real angle between two optical beams.

8. The method according to claim 2, comprising at least one iteration of the steps of:
acquiring the first position of the optical beam on the optical sensor;
at least one rotation of the attachment zone with respect to the alignment axis of the attachment zone;
acquiring the at least one second position of the optical beam on the optical sensor;
determining:
the angular deviation between the expected emission axis of the optical beam and the real emission axis of the optical beam, and/or
a position of a real optical focal spot of the camera on the optical sensor, and/or
the real emission axis of the optical beam, and/or
the difference between the expected angle between two optical beams and the real angle between two optical beams; and
each iteration being carried out at a different position of the attachment zone along the expected emission axis of the optical beam.

9. The method according to claim 1, in which:
the optoelectronic system is a LIDAR,
the movement system is a movement system with automatic control, such as, among others, a robotic arm or hexapod or any inclined platform; and
the attachment zone is a surface of the movement system, positioning and inclination of which are controlled.

10. A device for measuring parameters of an optical beam emitted by a LIDAR, said measurement device comprising:
a support suitable for receiving the LIDAR and arranged to modify a positioning of the LIDAR;
the measurement device including:
a movement system with automatic control comprising an attachment zone suitable for being moved along several axes;
an optical device attached to said attachment zone of the movement system;
the movement system is arranged to position the attachment zone with respect to the LIDAR and to orient an alignment axis of the attachment zone so that the alignment axis coincides with an expected emission axis of the optical beam; and
the optical device is arranged to measure one or more parameters of the optical beam.

11. The device according to claim 10, comprising a processing unit configured and/or programmed to calculate an expected emission axis of the optical beam, based on data relating to a direction of emission of a beam emitted by the LIDAR.

12. The device according to claim 10, in which the processing unit is configured and/or programmed to calculate a position and a direction of the attachment zone for which the alignment axis of the attachment zone is aligned with the expected emission axis of the optical beam.

13. The device according to claim 10, in which the movement system with automatic control is a robotic arm or hexapod or any inclined platform and the attachment zone suitable for being moved is a surface of the movement system, said surface being arranged to be rotated about the alignment axis of the attachment zone.

14. The device according to claim 10, in which the support is mainly comprised in one plane and is arranged to adjust, among others, the angle formed between a horizontal plane and the plane in which the support is comprised.

15. The device according to claim 10, in which the optical device is arranged to measure, at least one of:
a spatial positioning of a vector representative of the optical beam,
one or more spectral characteristic(s) of the optical beam,
one or more temporal characteristic(s) of the optical beam,
a polarization rate of the optical beam,
a gaussian propagation property of the optical beam,
one or more characteristic(s) associated with the phase of the optical beam,
a wave front of the optical beam,
an efficiency of the optoelectronic system, and
optical power of the optical beam.

16. The device according to claim 10, in which:
the optical device is a camera;
an optical axis of the camera describes a precession movement about the alignment axis;
the camera is arranged to:
measure a spatial positioning of a vector representative of the optical beam,
be rotated about the alignment axis of the attachment zone and
the processing unit is configured and/or programmed to determine an angular deviation between an expected emission axis of the optical beam and a real emission axis of said optical beam based on at least two positions of the beam emitted by the LIDAR on an optical sensor of the camera, said at least two positions of said optical beam comprising at least one position acquired subsequently and/or concomitantly and/or after the camera has been rotated.

17. The device according to claim 16, in which the processing unit is configured and/or programmed to determine:
a position of a real optical focal spot of the camera on the optical sensor, the position of the real optical focal spot corresponding to the position of a centre of a circle linking said at least two positions of the optical beam on the optical sensor; and
the real emission axis of the optical beam, said real emission axis comprising the position of the real optical focal spot on the optical sensor and an optical centre of the camera.

18. The device according to claim 16, in which the processing unit is configured and/or programmed to apply the step of determining an angular deviation to a set of beams emitted by the LIDAR.

19. Use of the device according to claim 16, for determining a difference between:
an expected angle between two optical beams emitted by a LIDAR; and
a real angle between said two optical beams emitted by the LIDAR.

20. Use of the device according to claim 16, for calibrating an inclinometer of a LIDAR.
